(19) United States
(12) Patent Application Publication
(10) Pub. No.: US 2003/0174219 A1
(43) Pub. Date: Sep. 18, 2003

(54) Image pickup and recording apparatus for recording a certain image separately from other image, and an image picking up and recording method

(75) Inventor: Jun Iijima, Tokorozawa-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: CASIO COMPUTER CO., LTD., Tokyo (JP)

(21) Appl. No.: 10/385,333

(22) Filed: Mar. 10, 2003

(30) Foreign Application Priority Data
Mar. 13, 2002 (JP) 68321 / 2002

(51) Int. Cl. H04N 5/222

(52) U.S. Cl. 348/231.99; 348/333.11; 348/333.02

(57) ABSTRACT

A favorite folder (history image folder) is prepared for storing reduced image files. The favorite folder is provided separately from a folder for storing a full image files which are created by a digital camera. The full image file is reduced to create the reduced image file of a small memory size. The reduced image file in the favorite folder can not be deleted in a normal delete mode. Even though the full image files are transferred to another memory device such that of a personal computer, the reduced image files are used for searching or content confirming purpose.

### FIELD OF THE INVENTION

The present invention relates to an image pickup and recording apparatus for a digital camera and an image picking-up and recording method.

### BACKGROUND OF THE INVENTION

A recent storage element such as a detachable memory device for use with a digital camera has increased in its storage capacity to more than several tens or hundred megabytes. Meanwhile, images to be recorded therein have become of high resolution, for example 2240×1680 pixels and a data size of such image will be of about 2 mega bytes.

However, though the storage capacity of the storage element has greatly increased, there is still a limitation in number of images to be stored therein. Therefore, a user of the digital camera is often required to make sure how much of memory capacity is left for recording another image data, and, if left less, further required to transfer the image data stored in the storage element to another storage device of large capacity, which is incorporated, for example, in a personal computer.

As a result, the user often meets an inconvenience in the course of reviewing images which were taken in the past, in other words, the user is not allowed to review them in a simple and instant manner, because all the images are not stored in one and same storage element but they are stored in plural separate storage apparatuses. Further, even though there is a limitation in number of images to be stored in the storage element of the digital camera, several tens or hundred images may be stored therein, and therefore it is not easy for the user to search his desired image out of the hundred images stored in the storage element.

### SUMMARY OF THE INVENTION

It is an aspect of the present invention to provide an image pickup and recording apparatus which comprises: image pickup means for taking a picture of an object to create full image data; first storage means for recording the full image data created by the image pickup means; selecting means operated by a user for selecting a full image data from among a plurality of full image data previously stored in the first storage means; data creating means for processing the full image data selected by the selecting means to create reduced image data; second storage means for storing independently of the full image data the reduced image data created by the data creating means; and display means responsive to request by the user for displaying an image based on the reduced image data stored in the second storage means.

It is another aspect of the present invention to provide an image pickup and recording apparatus which comprises: image pickup means for taking a picture of an object to create full image data; first storage means for recording the full image data created by the image pickup means; data creating means for processing the full image data created by the image pickup means to create reduced image data; second storage means for storing the reduced image data created by the data creating means in an recording area different from that where the full image data is recorded; and display means responsive to request by the user for displaying the reduced image data stored in the second storage means.

It is still another aspect of the present invention to-provide an image pickup and recording apparatus which comprises: image pickup means for taking a picture of an object to create full image data; first storage means for recording the full image data created by the image pickup means; data creating means for processing the full image data created by the image pickup means to create reduced image data; second storage means for storing the reduced image data created by the data creating means in an recording area different from that where the full image data is recorded; and display means responsive to request by the user for displaying the reduced image data stored in the second storage means.

It is yet another aspect of the present invention to provide a method of picking-up and recording an image which comprises the steps of: selecting in response to operation of a user a full image data from among a plurality of full image data previously stored; processing the selected full image data to create reduced image data; storing the created reduced image data independently of the selected full image data; and displaying the previously stored reduced image data upon request by a user.

It is other aspect of the present invention to provide a method of picking-up and recording an image comprising the steps of: taking a picture of an object to create full image data of the object; recording the created full image data in a memory area; processing the full image data to create reduced image data; storing the created reduced image data in a memory area separated from the memory area where the full image data is recorded; and displaying in response to request by a user the stored reduced image data.

It is still other aspect of the present invention to provide a memory medium storing program for making control section perform following functions, the control section being provided in an image pickup and recording apparatus for taking a picture of an object to create image data of the object and for storing the image data; selecting of a desired full image data from among the plural full image data stored previously; processing of the selected full image file to create reduced image data; controlling to store in a storage the created reduced image data independently of the full image data; and displaying of an image based on the reduced image data stored in the storage on a display.

### BRIEF DESCRIPTION OF THE DRAWINGS

FIG. 1 is a block diagram of a digital camera commonly used in preferred embodiments of the present invention.

FIG. 2A is a view showing a storage structure of a file in a memory card in a first embodiment of the invention.

FIG. 2B is a view showing a storage structure of a file in a memory card in a modified first embodiment of the invention.

FIG. 3 is a view illustrating transition in dialog windows displayed on a display device, which shows operation in a cool mode in the first embodiment of the invention.

FIG. 4 is an explanatory view illustrating the transition in dialog windows following those in FIG. 3.

FIG. 5 is an explanatory view illustrating the transition in dialog windows when a register command is selected, following those in FIG. 3.

FIG. 6 is an explanatory view illustrating the transition in dialog-windows when a display command is selected, following those in FIG. 3.

FIG. 7 is an explanatory view illustrating the transition in dialog windows when a delete command is selected, following those in FIG. 3.

FIG. 8A is a typical view illustrating memory space of a memory card in a second embodiment of the invention.

FIG. 8B is a typical view illustrating memory spaces in a memory card and an internal flash memory in a modified second embodiment of the invention.

FIG. 9 is a flow chart in an image pickup mode in the second embodiment.

FIG. 10 is a flow chart in a history mode in the second embodiment.

### DETAILED DESCRIPTION OF THE PREFERRED EMBODIMENTS

Now, referring to the attached drawings, embodiments of the present invention will be described in detail.

First Embodiment

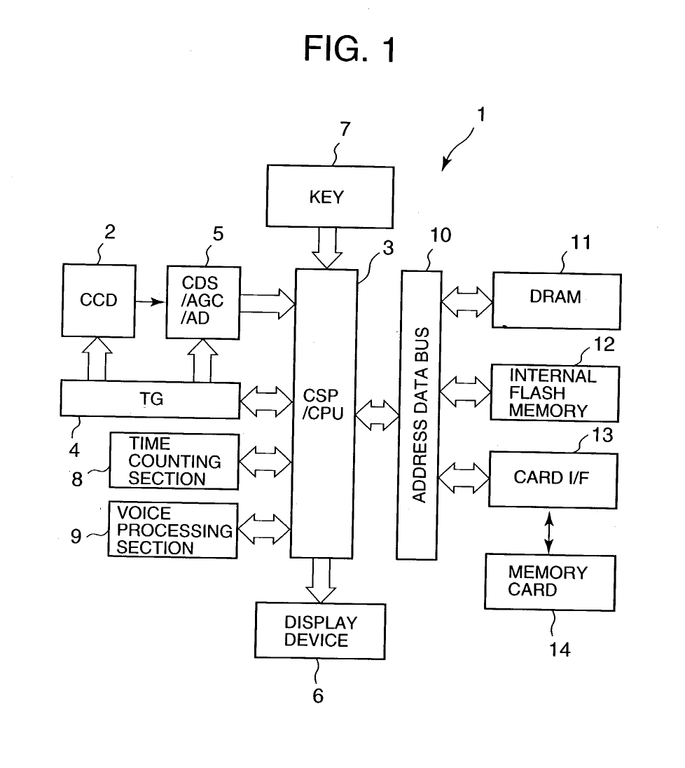

FIG. 1 is a block diagram showing a schematic structure of an image pickup and recording apparatus of the present invention, or a digital camera 1. The digital camera 1 is provided with functions of recording and reproducing not only a still image but also a moving image and a still image with voice added. The digital camera 1 comprises an image pickup means or CCD 2 and a digital signal processor (DSP)/Central Processing unit (CPU) 3. The DSP/CPU 3 further comprises one chip microcomputer, which has a function of processing various digital signals, such as processes for compression and expansion of image data and a process of audio data, and which controls operation of the digital camera 1. The DSP/CPU 3, is connected with a timing signal generator (TG) 4, which droves the CCD 2. The TG 4 is connected with a unit circuit 5, which is supplied with an analog image-pickup signal representing an optical image of an object output from the CCD 2. The unit circuit 5 includes a correlated double sampler (CDS) for maintaining an image pickup signal input thereto, an auto gain controller (AGC) for amplifying the image pickup signal, and an analog-digital converter (AD) for converting the amplified image pickup signal into a digital image pickup signal. An output signal from the CCD 2 is converted into a digital signal through the unit circuit 5, which is supplied to the DSP/CPU 3.

The DSP/CPU 3 is connected with a display device 6, a key input section (KEY) 7, a time counting section 8, a voice processing section 9. and further connected to DRAM 11, an internal flash memory 12, and a card interface 13 through an address data bus 10. A memory card 14 is detachably received in a card slot of a camera body (not shown) and connected to the card interface 13.

The DRAM 11 is a buffer for temporarily storing image data of the object, which data has been obtained by the CCD 2 and subjected to an analog-digital conversion process, and is also used as a working memory for the DSP/CPU 3. The image data temporarily stored in the DRAM 11 is compressed and encoded by the DSP/CPU 3 and is converted into a still image file or a moving image file in a predetermined format (e.g. JPEG format), which is finally recorded on the memory card 14. The internal flash memory 12 stores operation program for the DSP/CPU 3, and other data to be used for controlling various sections. The DSP/CPU 3 works in accordance with the operation program to control the digital camera 1, providing various functions as a camera, and functions as data creating means to generate a reduced image data.

The display device 6 comprises a color liquid crystal display (LCD) and a driving circuit for the display device 6. The display device 6 displays a through image of an object image generated by the CCD 2 while in a state waiting for an image picking-up operation, and displays an expanded image read out from the memory card 14 in a reproduction mode for reproducing recorded images. The key input section 7 includes plural operation keys such as a shutter key, power source key, a MENU key and a cross key. The key input section 7 generates and supplies in response to operation of the user a key input signal to the DSP/CPU 3 to perform a function of selection means in cooperation with the DSP/CPU 3. The time counting section 8 has a calendar function for counting a date and a time piece function for counting a time, and sends date data and time data to the DSP/CPU 3 if required, in the image picking-up operation. The voice processing section 9 comprises an internal microphone, an amplifier, an A/D converter, and an internal speaker, and converts voice into a digital signal, which voice has been input from the internal microphone in an image pickup mode for taking a still picture with voice, and further sends the digital signal to DSP/CPS 3. The digital signal or audio data sent to the DSP/CPU 3 is compressed into an audio file in a predetermined format, which is recorded in the memory card 13 in association with a still image file. Thus recorded audio file is reproduced together with the associated still image file and output through the internal speaker.

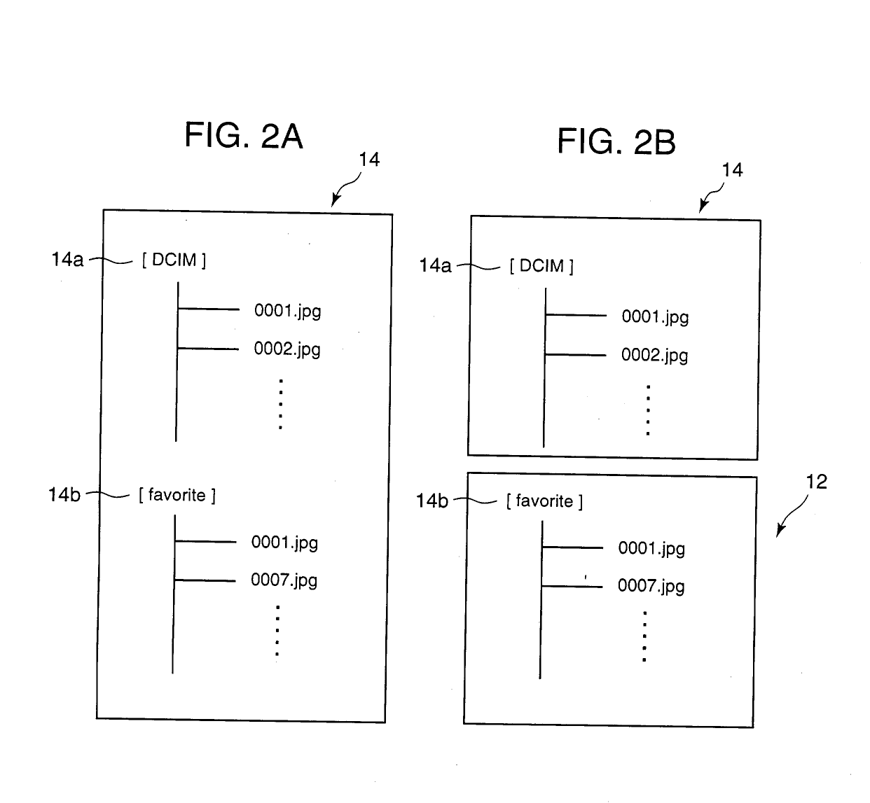

The memory card 14 constitutes image reducing and recording means of the present invention, and has a file storage structure shown in FIG. 2. The memory card 14 includes 2 folders, a DCIM folder 14a and a favorite folder 14b. In the DCIM folder 14a are stored image files (0001.jgp, 0002.jpg, . . . ), which are created in response to image-pickup operation by the user. The image files (hereafter, full image files) created upon the image-pickup operation each include full image data, such as a still image data, a moving image data (a movie), or a still image data with voice added, which full image data are added with image-pickup data and date data added. Further, the full image file can be a file to which a reduced size image of about 320×240 pixels is added for preview or a thumb-nail image is added. The thumb-nail file is reduced smaller in image size than the preview image. The full image file is such file that can be deleted or transferred in a normal delete mode, and only this full image file can be deleted or transferred upon delete operation or image transfer operation in a mode other than the cool mode. Full image data which is stored as a full image file is equal in size to an image file which is created in an image quality mode which has been set for taking a picture. For example, the size of a still image is 2240×1680 pixels, or 1600×1200 pixels.

In the favorite folder 14b in FIG. 2 are stored reduced image files (0001.jpg, 007.jpg, and so on) each corresponding to either of the full image files stored in the DCIM folder 14a. The reduced image file can not be deleted in the normal delete mode. A size of image data which is stored as a reduced image file is equal to a size that has been set in accordance with number of pixels (resolution of the display screen) of a color LCD used in the display device 6. In the present embodiment, the reduced image data is of Quarter Video Graphics Array (QVGA) size, which includes only pixels contributing to improve resolution of the color LCD display, excluding pixels not contributing to the resolution improvement, or of about 320×240 pixels, and the file size (or data size) thereof is about 20 kilobytes. The image size which is stored as the reduced image file is different in its most preferable size depending on a resolution of a display screen of the image pickup and recording apparatus, and it is the most preferable that the image size is equal to the resolution of the display screen of the image pickup and recording apparatus, but the image size may be larger or smaller than the resolution of the display screen.

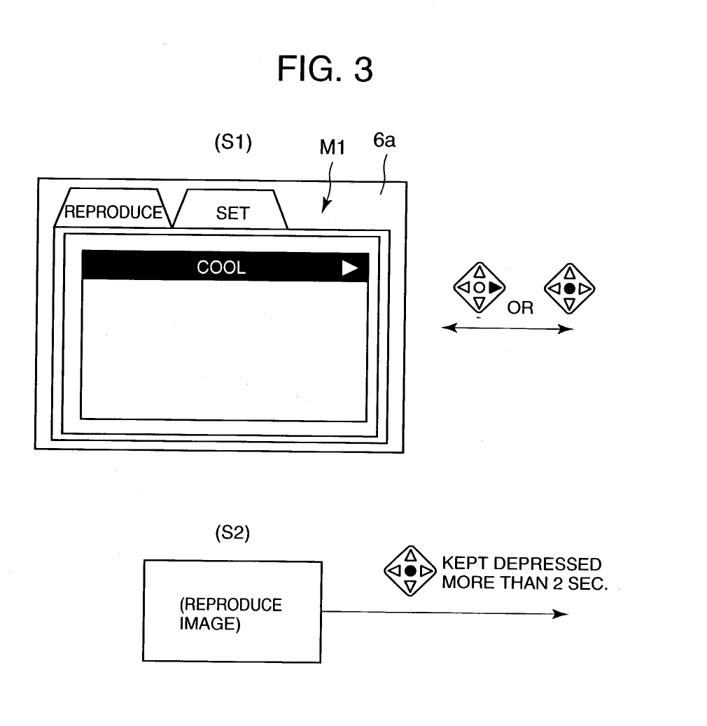

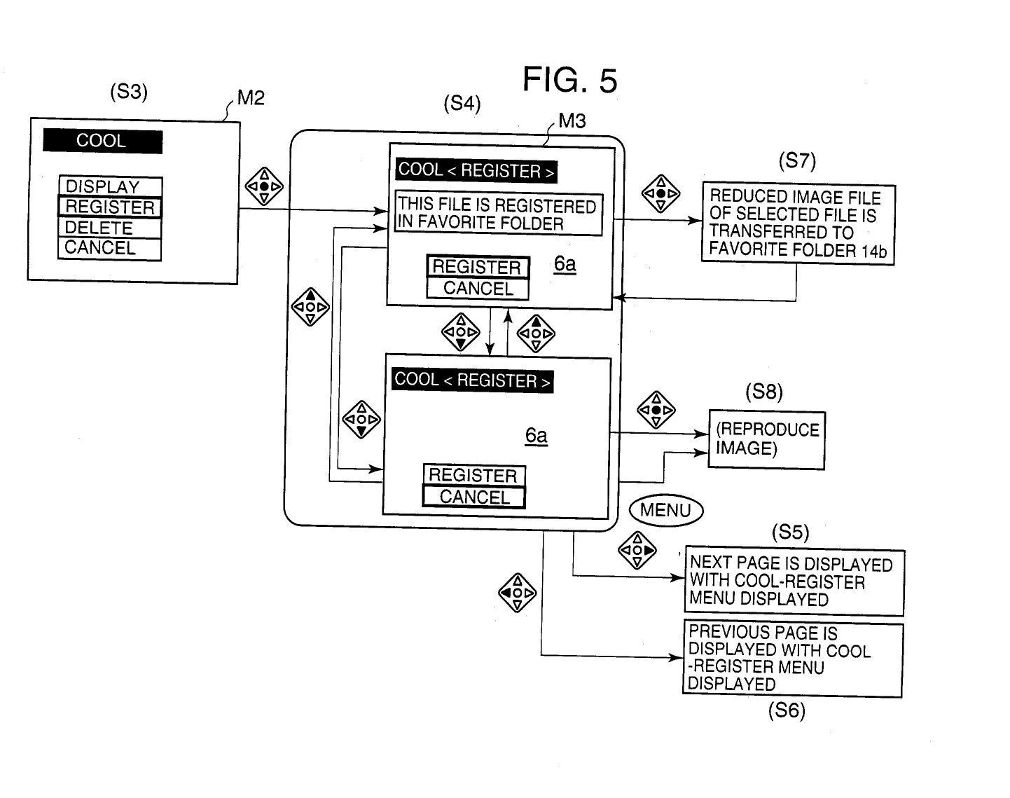

Now, operation of the present invention in the digital camera 1 with the structure mentioned above will be described in detail hereafter. FIG. 3 through FIG. 7 are views illustrating key operations performed by the user in the cool mode set under a reproducing mode and showing transition in dialog windows M1 displayed in response to the user's operations on a display screen 6a of the display device 6, where the user operates the cross key ([↑], [↓], [←], [→], and [SET]) and [MENU] key.

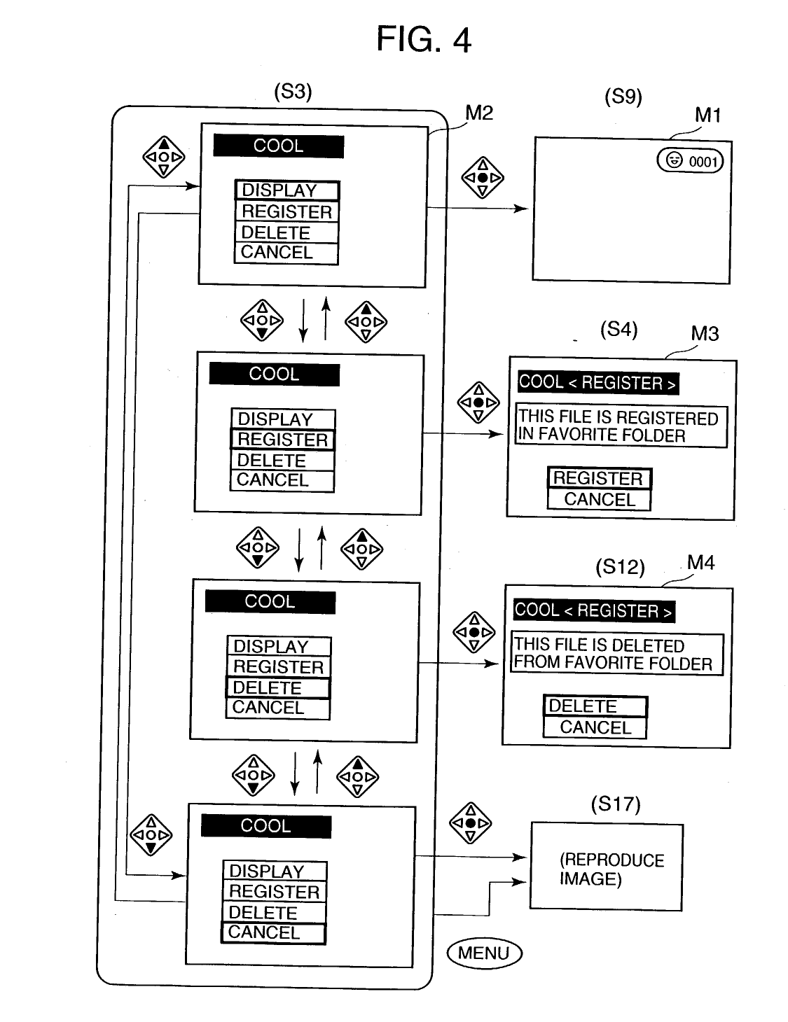

As shown in FIG. 3, when the digital camera 1 is set to the reproducing mode for reproducing recorded images (still images or moving images), and the user selects the cool mode with the dialog window of a function selection menu M1 displayed on the display screen 6a of the display device 6 (S1), or the user keeps the [SET] key depressed for more than 2 seconds with an image displayed in the reproducing mode (S2), then the digital camera 1 starts operation in the cool mode. Then, the digital camera 1 displays a cool menu M2 (S3) as shown in FIG. 4. In the cool menu M2, commands such as “DISPLAY”, “REGISTER”, “DELETE”, and “CANCEL” are displayed for selection. The user selects his or her desired command by using the [↑] and/or [↓] key and depresses the [SET] key with the desired command selected to finally designate the command. Then, the digital camera 1 starts operation in response to the designated command.

Now, operation of the digital camera 1 performed when each command is designated will be described hereafter.

“CANCEL” Command:

When the “CANCEL” command is designated, the display screen returns to the display of the image of the full image file (S17) which has been on display before the digital camera 1 is brought to the cool mode. The digital camera 1 works in the similar manner when the [MENU] key is depressed.

“REGISTER” Command:

When the “REGISTER” command is designated, the digital camera 1 reproduces the full image file from the DCIM folder 14a of the memory card 14 and displays the same on the display screen 6a of the display device 6 (S4), while displaying a cool-register menu M3 (on screen display, OSD). When a moving image is reproduced, a first frame of image of the moving image is displayed. When the user depresses the [→] key, a next page (or frame) of the still image, or the moving image is retrieved and displayed (S5), and when the [←] key is depressed, a previous page (or frame) of the image is retrieved and displayed (S6). When the user operates the [→] key or the [←] key to make an image displayed, and further depresses the [SET] key with “REGISTER” being selected by operation of the [↑] key or the [↓] key, the digital camera 1 reduces to QVGA size the full image file of the image which is on display at the time when the above key is operated by the user to obtain a reduced image file in the above favorite folder 14b. When image data of different sizes are included in the full image folder, a reducing process is not needed to be performed, but image data suitable for the reduced image file is selected among those in the full image file to create a reduced image file in the favorite folder 14b (S7).

The reduced image file is given a file name based on the name of the full image file. To take an example, the reduced image file is given a file name of “0001s.jpg” based on the file name of “0001.jpg” of the full image file. (Refer to FIG. 2A.) Added data to be added to the reduced image file, such as date data, is not changed except image data included in the full image file. In case that a moving image is selected, if each of still image frames constituting the moving image exceeds QVGA size, then the frames are reduced to QVGA size and copied, and if each of still image frames constituting the moving image is smaller than QVGA size, then the frames are not reduced and just copied. At this time, audio data is recorded with all or either of channel number, sampling rate, or quantifying bit number reduced. When memory is left so little in the memory card 14 that a reduced copy of the selected full image file can not be stored, then a notice saying “No-data can be recorded” is displayed and the display screen returns to the display of the image of the full image file which has been on display before the digital camera 1 is brought to the cool mode. When the reduced image file is copied, then next full image file is reproduced and displayed with the cool register menu M3 displayed.

Meanwhile, when, in the cool register menu M3, the user depresses the [SET] key or [MENU] key with “CANCEL” selected by operating the [↑] key and/or the [↓] key, the display screen returns to the display of the image of the full image file which has been on display before the digital camera 1 is brought to the cool mode (S8).

“DISPLAY” Command:

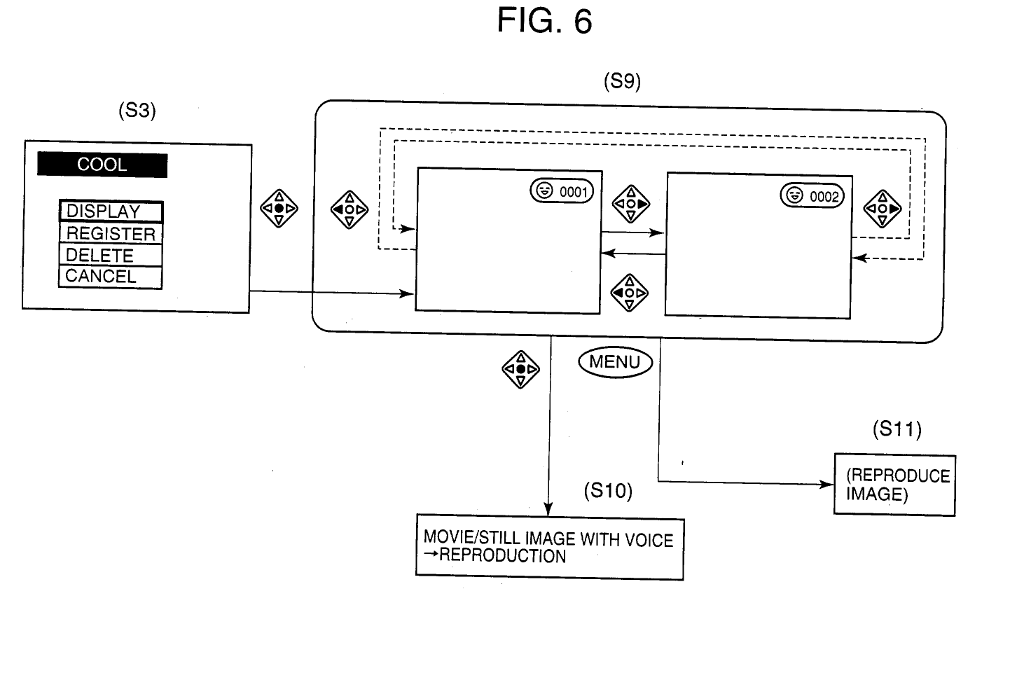

When the “DISPLAY” command is designated, the digital camera 1 reproduces and displays on the display screen 6a of the display device 6 the reduced image file stored in the favorite folder 14b in the memory card 14 (S9), as shown in FIG. 6. For the moving image, the first frame of image of the moving image is displayed. Upon operation by the user of the [→] key or the [←] key, the following or previous page (frame) of the image is displayed. When the user depresses the [SET] key while an image with voice added or an image of moving image with voice added is being displayed, the voice is reproduced (S10). When the user depresses the [MENU] key, the display screen returns to the display of the image of the full image file which has been on display before the digital camera 1 is brought to the cool mode (S11).

“DELETE” Command:

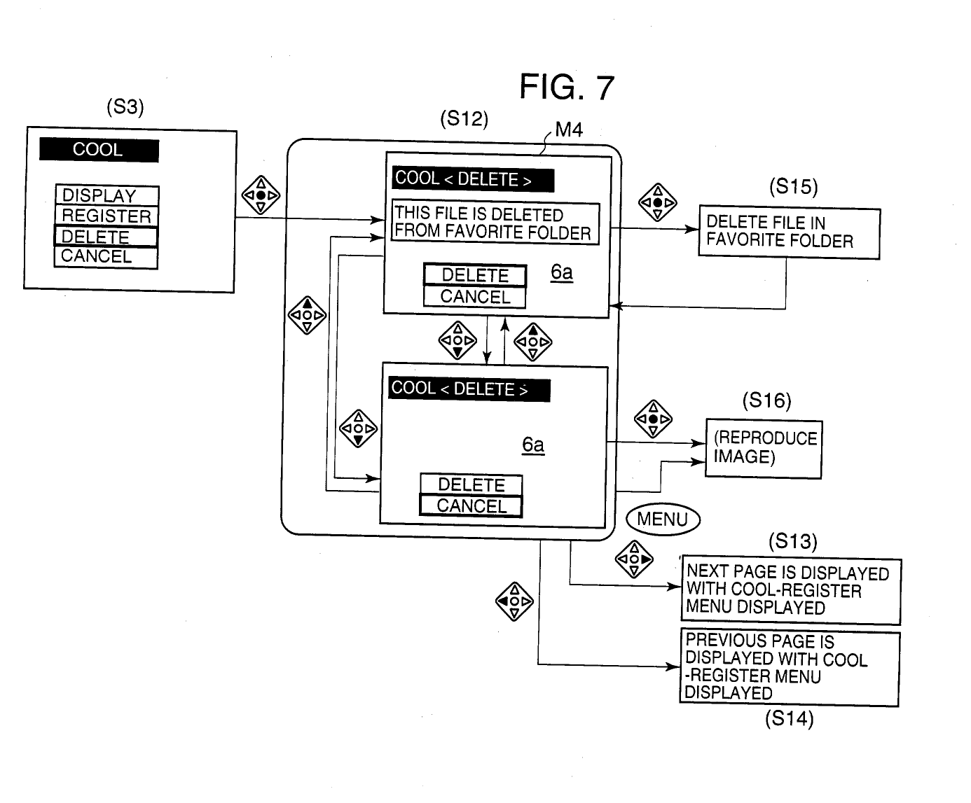

When the “DELETE” command is designated, the digital camera 1 reproduces the reduced image file from the favorite folder 14b in the memory card 14 and displays the same on the display screen 6a of the display device 6 with the cool-delete menu M4 displayed (S12), as shown in FIG. 7. For the moving image, the first frame of image of the moving image is displayed. When the user depresses the [→] key with the first frame of image displayed, the following page (frame) of the image (still image or moving image) is displayed (S13), or when the user depresses the [←] key, the previous page (frame) of the image (still image or moving image) is displayed (S14). When the user operates the [→] key or the [←] key to make an image displayed, and further depresses the [SET] key with “DELETE” being selected by operation of the [↑] key or the [↓] key, then the digital camera 1 deletes the from the favorite folder 14b the image file of which image is on display at the time (S15). Thereafter, the digital camera 1 reproduces and displays the following full image file with the cool-delete menu M3 displayed.

Meanwhile, when, in the cool-delete menu M4, the user depresses the [SET] key or [MENU] key with “CANCEL” selected by operating the [↑] key and/or the [↓] key, the display screen returns to the display of the image of the full image file which has been on display before the digital camera 1 is brought to the cool mode (S16).

As described above, as far as the memory card 14 is not formatted, even though an image (the full image file) obtained previously is transferred to a personal computer, or plural full image files are deleted in block, the user of the digital camera 1 is allowed to immediately confirm contents of the previously obtained images by registering them in the cool mode. Since the reduced image file is extremely smaller in size than the full image file, and less memory capacity is used for storing the reduced file image, the user is not required to pay attention to memory capacity left in the memory card 14 for storing the reduced image files. As described above, without spoiling the user friendliness of the digital camera 1, the present invention is conveniently used for effectively maintaining images.

In the present embodiment, the image size of the reduced image file is determined depending on the resolution of the display screen 6a of the display device 6. Therefore, the reduced image file is displayed in QVGA size, which allows display of an image of appropriate visual quality, not over or less visual quality, and the QVGA size display further allows the user to confirm the contents of the image of visual quality substantially same as that shown at taking a picture, providing improved usability of the digital camera.

In the present embodiment, the favorite folder 14a for storing the reduced image files is provided in the memory card 14, but the favorite folder 14a may be included in the internal flash memory 12, as shown in FIG. 2B.

Second Embodiment.

A second embodiment of the invention will be described in detail hereafter. In the second embodiment, the digital camera has the same structure as that of the first embodiment and is given an additional operation mode of a history mode set under the reproducing mode.

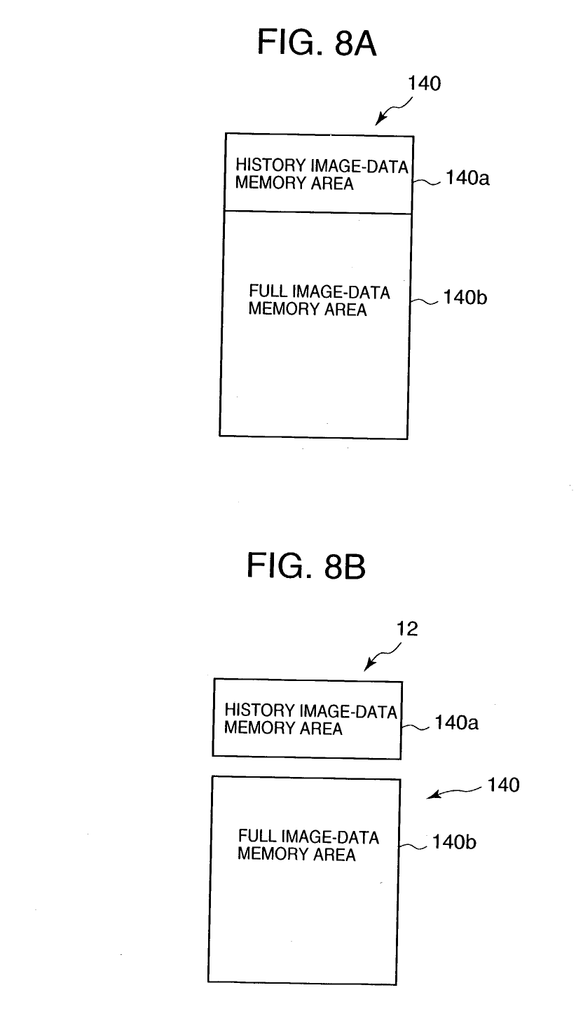

Now, differences in structure between the digital camera of the second embodiment and the digital camera 1 of the first embodiment will be described. The digital camera of the second embodiment is provided with a memory card 140 instead of the memory card 14. The memory card 140 has a history folder and a DCIM folder which is same as that of the first embodiment. FIGS. 8A and 8B are typical views each illustrating memory spaces in the memory card 140. The memory card 140 has a history image-data memory area 140a corresponding to the history folder, and a full image-data memory area 140b corresponding to the DCIM folder. The history file comprises reduced image data of an image similar to the full image file stored in the above DCIM folder, which data is reduced to the QVGA size similar to that in the first embodiment, and can not be deleted in the normal delete mode. The history folder stores the history image file, and the history image data is stored in the history image-data memory area 140a. In the second embodiment, the history image-data memory area 140a is fixed to a predetermined size, for example, to about 5 megabytes which is a size for storing about 250 image files each including image data of the QVGA size. Similarly as in the first embodiment, the best size of the history image data is different depending on the resolution of the display screen of the image pickup and recording apparatus. It is most preferable that the size of the history image data is equal to the resolution of the display screen of the image pickup and recording apparatus, but the size of the history image data may be somewhat larger or smaller than the resolution of the display screen.

In the present embodiment, in the internal flash memory 12 are stored program that has the DSP/CPU 3 provide functions of data creating means for creating reduced image data, control means, judging means, and display control means. Now, performance of the digital camera having the above structure in the image pickup mode and in the history mode will be described hereafter.

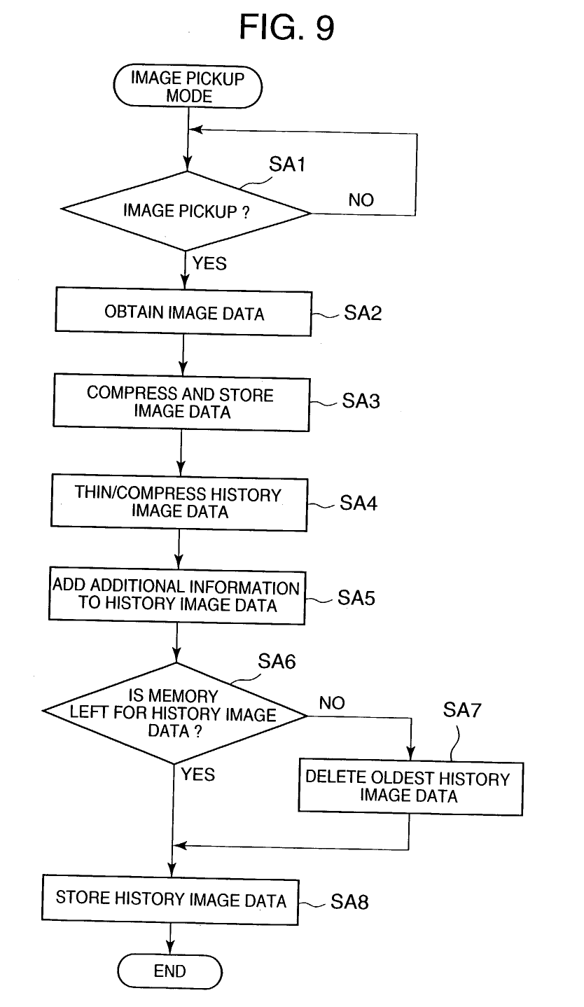

FIG. 9 is a flow chart of the performance of the digital camera in the image pickup mode. When an image pickup operation is effected by operating the shutter key (STEP SA1, YES), the digital camera 1 obtains an image of a object through the CCD 2 and stores image data of the object in the DRAM 11 (STEP SA2). The stored image data is compressed and added with image-pickup date data and image-pickup condition data, and further recorded as full image file in the full image-data memory area 140b on the memory card 140 (STEP SA3). The image data stored in the DRAM 11 is subjected to a thinning process, whereby reduced image data or history image data of QVGA size is obtained (STEP SA4). The compressed data is added with additional information including date information and link information (STEP SA5). The date information is common to the full image file and the compressed data, and the date data added to the full image file is employed for the date information regardless of a date when the history image data is created. The link information is for identifying the previously stored image data and comprises a file name of the image data, that is, the full image file in the present embodiment. When image data which is different in size from the image data included in the full image file is required to be added, creation of the image data which is different in size from the full image file and creation of the history image data are performed in the same compression process.

When a space is left in the history image-data memory area 140a (STEP SA6, YES), then the history image data is immediately stored (STEP SA8), and when no space is left in the history image-data memory area 140a (STEP SA6, NO), then the oldest history image data stored therein is deleted to secure a space for storing data (STEP SA7), and the history image data is stored in the space secured in the history image-data memory area 140a. The above processes are repeatedly effected every time the image pickup operation is performed, whereby the latest history image data are at all times stored in the history image-data memory area 140a.

Although not shown in the flow chart, the processes similar to the above are performed in the image pickup mode for a still image with audio data added. But the audio data is not stored in the history image-data memory area 140a.

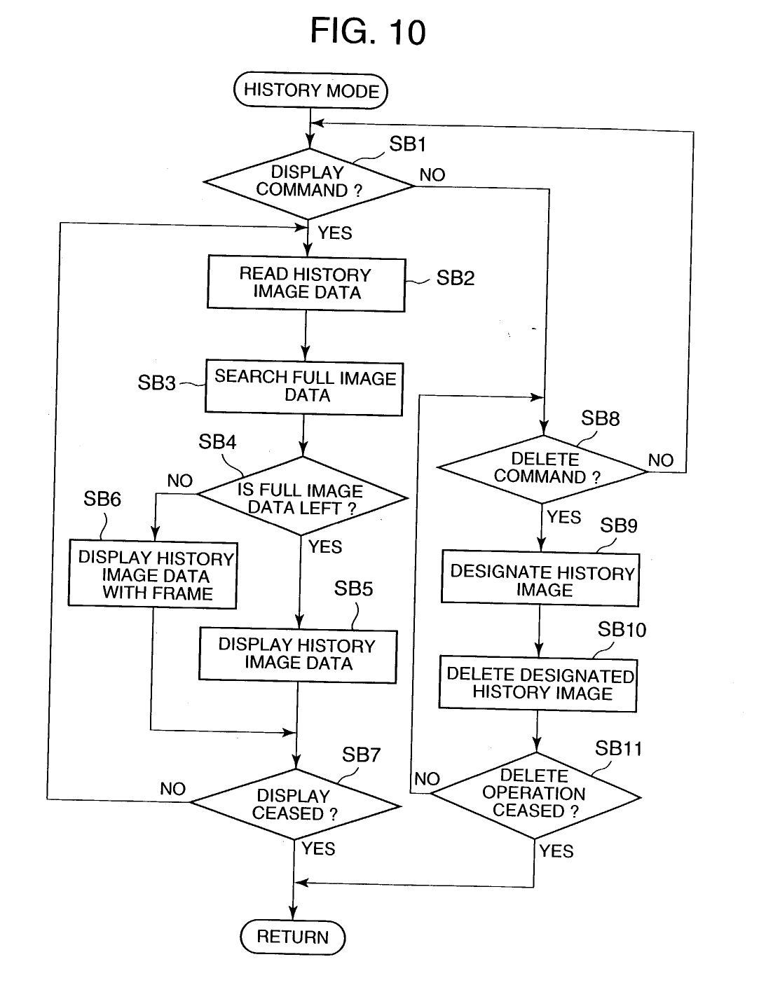

In the image pickup mode for a moving image, if a frame size of each still image included in the moving image exceeds the QVGA size, processes similar to the above are performed to create history image data, storing the same in the memory area 140a. If the frame size of each still image included in the moving image is less than the QVGA size, the still image included in the moving image is stored without any modification in the history image-data memory area 140a. Meanwhile, FIG. 10 is a flow chart of the performance of the digital camera in a history mode. When a history mode is selected in the reproducing mode, the digital camera 1 displays dialog menu on the display screen of the display device 6 in a similar manner to the performance in the cool mode of the first embodiment. The digital camera 1 works depending on the command designated by the user operating the key, as described below.

When the “DISPLAY” command is designated in the history mode (STEP SB1, YES), the history image data having the oldest date data is read out from the memory card 140 (STEP SB2). The digital camera 1 searches full image data depending on the link information (filename) added to the read out history image data (STEP SB3). If the image data is found (STEP BS4, YES), an image of the read out history image data is displayed on the display device 6 (STEP SB5). If no image data is found (STEP SB4, NO), an image of the read out history image data is displayed with a frame on the display device 6 (STEP SB6). The image displayed with the frame notices the user that the image data (image pickup data) corresponding to the image displayed with the frame has been deleted. In STEP SB5 and SB6, the moving image is displayed, the process for displaying the moving image is performed.

If the user has not given an instruction to cease display operation (STEP SB7, NO), the process returns to STEP SB2, where the following history image data is read out from the memory card 140, and thereafter the above mentioned processes are repeatedly performed. If the user operates to display the following page (frame) of image (next-page designating operation) during the process, the history image data with date data of the following date is read out, and on the contrary the user operates to display the previous page (frame) of image (previous-page designating operation), the history image data with date data of the previous date is read out. (When the image of the oldest date is displayed, the image of the latest date is read out.) When the user gives an instruction to cease the display operation (STEP SB7, YES), the process returns to STEP SB1.

When the “DELETE” command is designated in the history mode (STEP SB1, NO, STEP SB8, YES), history images of the history image data stored in the the history image-data memory area 140a of the memory card 140 are successively displayed on the display device 6. When a desired history image is designated by previous-page or next-page designating operation performed by the user (STEP SB9), the designated history image data is deleted from the history image-data memory area 140a (STEP SB10). Then, when the user gives no instruction to cease DELETE operation (STEP SB11, NO), the process returns to STEP SB8, and the processes of STEP SB9 and STEP SB10 are repeatedly performed with the history image displayed, which history image data has been deleted last. When the user gives an instruction to cease DELETE operation (STEP SB11, YES), the process returns to STEP SB1, and the above processes are repeatedly performed until an instruction is given to cease the history mode.

In the digital camera 1 used in the second embodiment, even after the full image files previously stored therein have been transferred to a personal computer, the user is allowed to review history of image picking-up operations performed during a latest certain period and images obtained by such image picking-up operations by selecting the history mode. Further, the user can easily search the full image files throughout the personal computer with reference to date data added to history image data. Since history image data is small in data size, and does not consume so much memory, the history image-data memory area 140a to be secured in the memory card 140 may be small and a large number of history image files are allowed to be stored therein. As a result, the user can review history of the image operations performed in a long period of time, which allows effective image-file management, providing improved usability of the camera.

Further, the history image data is small in size, the user can scroll through the history image data in a quick manner to review contents of the images.

In the above embodiment, the folder for string history image files is recorded in the memory card 140, but may be recorded in the internal flash memory. In this case, when the memory card 140 is removed from the camera body, link or relationship information added to the history image data must be deleted in block.

In the embodiment, the history image-data memory area 140a is previously fixed in memory size, but the camera may be designed so as to allow the user to set such memory size preferably by choosing number of bytes of a memory area or the rate of such memory size in the memory card 140. These techniques may used in the first embodiment in a similar manner as in the second embodiment. The image data storing area (not shown) corresponding to the favorite folder 14b in the memory card 14 may be arranged to be set by the user.

Further, in the embodiment, the history image-data memory area 140a is provided in the memory card 140, but it may be provided in the internal flash memory 12, as shown in FIG. 8B.

What is claimed is:

1. An image pickup and recording apparatus comprising:
image pickup means for taking a picture of an object to create full image data; first storage means for recording the full image data created by the image pickup means;
selecting means operated by a user for selecting a full image data from among a plurality of full image data previously stored in the first storage means;
data creating means for processing the full image data selected by the selecting means to create reduced image data;
second storage means for storing independently of the full image data the reduced image data created by the data creating means; and
display means responsive to request by the user for displaying an image based on the reduced image data stored in the second storage means.

2. The image pickup and recording apparatus according to claim 1, wherein the data creating means creates reduced image data of a size corresponding to resolution of the display means.

3. The image pickup and recording apparatus according to claim 1, wherein the data creating means creates reduced image data by thinning out data from the full image file.

4. The image pickup and recording apparatus according to claim 1, wherein the data creating means extracts reduced image data in the full image data to create the reduced image data.

5. The image pickup and recording apparatus according to claim 1, wherein first storage means and the second storage means are provided are provided respectively in separate memory areas on one and same recording medium.

6. The image pickup and recording apparatus according to claim 1, wherein first storage means and the second storage means are provided in different recording media, respectively.

7. The image pickup and recording apparatus according to claim 6, wherein first storage means is provided in a memory card to be detachably installed to the image pickup and recording apparatus and the second storage means is provided in an internal memory of the image pickup and recording apparatus.

8. The image pickup and recording apparatus according to claim 1, wherein the data creating means adds identifying information to the reduced image data, the identifying information used for identifying original full image data from which the reduced image data is created, wherein the data creating means comprises: judging means for judging whether or not the original full image data is left stored, and
display control means for controlling the display means so as to display an image of the reduced image data in a format decided depending on the result of the judgment by the judging means.

9. The image pickup and recording apparatus according to claim 1, further comprising delete means for deleting only the full image data stored in the first storage means.

10. An image pickup and recording apparatus comprising:
image pickup means for taking a picture of an object to create full image data;
first storage means for recording the full image data created by the image pickup means;
data creating means for reducing the full image data to create reduced image data;
second storage means for storing the reduced image data created by the data creating means in a memory area other than that where the full image data is recorded; and
display means responsive to request by a user for displaying the reduced image data stored in the second storage means.

11. The image pickup and recording apparatus according to claim 10, wherein the data creating means creates reduced image data of all of the full image data obtained by the image pickup means.

12. The image pickup and recording apparatus according to claim 10, further comprising:
control means for replacing the oldest data with the latest data in the plural reduced image data stored in the second storage means.

13. The image pickup and recording apparatus according to claim 10, wherein the first storage means and the second storage means are provided respectively in separate memory areas on one and same recording medium.

14. The image pickup and recording apparatus according to claim 10, wherein first storage means and the second storage means are provided in different recording media, respectively.

15. The image pickup and recording apparatus according to claim 14, wherein first storage means is provided in a memory card to be detachably installed to the image pickup and recording apparatus and the second storage means is provided in an internal memory of the image pickup and recording apparatus.

16. The image pickup and recording apparatus according to claim 10, further comprising:
delete means for deleting only the full image data stored in the first storage means.

17. The image pickup and recording apparatus according to claim 10, further comprising:
delete means for deleting only the reduced image data stored in the second storage means.

18. The image pickup and recording apparatus according to claim 10, wherein the data creating means adds common information to the reduced image data, the common information being commonly added to original full image data from which the reduced image data is created.

19. The image pickup and recording apparatus according to claim 18, wherein the common information includes date information which is the same as that is added to the original full image data.

20. The image pickup and recording apparatus according to claim 10, wherein the data creating means adds relation information to the reduced image data, the relation information representing relationship between the reduced image data and original full image data from which the reduced image data is created.

21. The image pickup and recording apparatus according to claim 20, wherein the relation information represents a filename of the original full image data.

22. The image pickup and recording apparatus according to claim 10, wherein the data creating means adds identifying information to the reduced image data, the identifying information prepared for identifying original full image data from which the reduced image data is created, wherein the data creating means comprises:
judging means for judging whether or not the original full image data is left stored in the first storage means, and
display control means for controlling the display means so as to display an image of the reduced image data in a format decided depending on the result of the judgment by the judging means.

23. A method of picking-up and recording an image comprising the steps of: selecting in response to operation of a user a full image data from among a plurality of full image data previously stored;
processing the selected full image data to create reduced image data;
storing the created reduced image data independently of the selected full image data; and
displaying the previously stored reduced image data upon request by a user.

24. A method of picking-up and recording an image comprising the steps of:
taking a picture of an object to create full image data of the object;
recording the created full image data in a memory area;
processing the full image data to create reduced image data;
storing the created reduced image data in a memory area separated from the memory area where the full image data is recorded; and
displaying in response to request by a user the stored reduced image data.

25. A memory medium storing program for making control section perform following functions, the control section being provided in an image pickup and recording apparatus for taking a picture of an object to create image data of the object and for storing the image data;
selecting of a desired full image data from among the plural full image data stored previously;
processing of the selected full image file to create reduced image data;
controlling to store in a storage the created reduced image data independently of the full image data; and
displaying of an image based on the reduced image data stored in the storage on a display.
